(19) United States
(12) Patent Application Publication
(10) Pub. No.: US 2009/0277805 A1
(43) Pub. Date: Nov. 12, 2009

(54) ELECTROCHEMICAL SENSORS, SENSOR SYSTEMS AND METHOD OF SENSING ANALYTES

(76) Inventors: SHIGERU AMEMIYA, Pittsburgh, PA (US); YUSHIN KIM, Pittsburgh, PA (US)

Correspondence Address: BARTONY & HARE, LLP, 1806 FRICK BUILDING, 437 GRANT STREET, PITTSBURGH, PA, 15219-6101, US

(21) Appl. No.: 12/432,308

(22) Filed: Apr. 29, 2009

Related U.S. Application Data
(60) Provisional application No. 61/048,775, filed on Apr. 29, 2008.

(51) Int. Cl. G01N 27/26; G01N 27/333

(52) U.S. Cl. 205/775; 204/418

(57) ABSTRACT

A sensor, includes a working electrode including a first layer formed of a polymeric material. The first layer includes a first surface across which an analyte in a sample can be transported and a second surface generally opposite of the first surface. The first layer satisfies the formula l≦(σDₘRT/|zᵢ|FV)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10. The working electrode also includes a second layer in contact with the second surface of first layer. The second layer is adapted to undergo at least one of a reduction reaction or an oxidization reaction. The working electrode further includes a support including a solid electrically conductive material in electrical connection with the second layer. The solid electrically conductive material can, for example, include a metal such as gold, platinum etc. or a conductive carbon.

### CROSS-REFERENCE TO RELATED APPLICATION

The present invention claims benefit of U.S. Provisional Patent Application Ser. No. 61/048,775, filed Apr. 29, 2008, the disclosure of which is incorporated herein by reference.

### GOVERNMENTAL INTEREST

This invention was made with government support under grant no. CHE-0645623 awarded by the National Science Foundation. The government has certain rights in this invention.

### BACKGROUND OF THE INVENTION

The present invention relates to electrochemical sensors, electrochemical sensor systems and methods of sensing analytes and, particularly, to electrochemical sensors and sensor systems including a working electrode including a thin liquid membrane and to methods of sensing analytes using a working electrode including a thin liquid membrane.

The following information is provided to assist the reader to understand the invention disclosed below and the environment in which it will typically be used. The terms used herein are not intended to be limited to any particular narrow interpretation unless clearly stated otherwise in this document. References set forth herein may facilitate understanding of the present invention or the background of the present invention. The disclosure of all references cited herein are incorporated by reference.

The response mechanism of liquid membrane ion-selective electrodes (sometimes referred to as ISEs) is based on ion transfer at the interface between two immiscible electrolyte solutions (sometimes referred to as ITIES). Potentiometric ion-selective electrodes, based on selective equilibrium partitioning of an analyte ion across a nonpolarizable liquid membrane/water interface, have been well developed and used for a variety of clinical and biological analyses.

For example, potentiometric ion-selective electrodes based on plasticized poly(vinyl chloride) (PVC) membranes have been successfully used for clinical ion analysis in undiluted blood. Recently, potentiometric polyion-sensitive electrodes have been developed using PVC membranes doped with lipophilic anion-exchangers (lipophilic cationic receptors) for polyanions, e.g., methyltridodecylammonium for heparin, or with lipophilic cation-exchangers (lipophilic anionic receptors) for polycations, e.g., dinonylnaphthalene sulfonate for protamine.

On the other hand, amperometric and voltammetric counterparts have found many fewer analytical applications.

In one such potential application, it has been demonstrated that solid-supported ion-selective electrodes including a plasticized poly(vinyl chloride) membrane having a thickness between 3 and 4 μm supported on gold with an intermediate conducting polymer layer of poly(3-octylthiophene) (POT) were suitable for voltammetric anion detection. Stripping voltammetry with such solid-supported ion-selective electrodes was demonstrated for heparin. J. Guo and S. Amemiya, “Voltammetric heparin-selective electrode based on thin liquid membrane with conducting-polymer-modified solid support”, Anal. Chem., 2006, 78, 6893-6902, the disclosure of which is incorporated herein by reference. Cyclic voltammetry of perchlorate in that paper provided a detection limit in the micromolar range.

Although progress has thus been made in potentiometric, voltammetric and amperometric analytical applications, it remains desirable to develop improved electrochemical sensors, electrochemical sensor systems and method of detecting analytes that, for example, provide improved response times and improved detection limits.

### SUMMARY OF THE INVENTION

In one aspect, the present invention provides a sensor, including a working electrode including a first layer formed of a polymeric material. The first layer includes a first surface across which an analyte in a sample can be transported and a second surface generally opposite of the first surface. The first layer satisfies the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10. In several embodiments, σ is no greater than 7, 5, 2.5, or even 1. The working electrode also includes a second layer in contact with the second surface of the first layer. The second layer is adapted to undergo at least one of a reduction reaction or an oxidization reaction. The working electrode further includes a support including a solid electrically conductive material in electrical connection with the second layer. The solid electrically conductive material can, for example, include a metal such as gold, platinum etc. or a conductive carbon.

In a number of embodiments, the effective thickness of the first layer is in the range of approximately 0.25 μm to 3.25 μm. The effective thickness represents an average thickness of the first layer and is calculated from σ by using the aforementioned equation (or equation 1 as defined below). A σ value can be determined experimentally by cyclic voltammetry. In several embodiments, the maximum thickness of the first layer is in the range of approximately 0.25 μm to 3.25 μm.

In several embodiments, the second layer comprises a polymeric material. The second layer can, for example, include a conductive polymeric material. Examples of suitable conductive polymers include, but are not limited to, one of a polypyrrole, a polythiophene and a polyaniline. In an umber of embodiments, the conductive polymer is poly(3-octylthiophene) or poly(3,4-ethylenedioxythiophene).

The first layer can, for example, operate or function as a liquid membrane or an ion-selective liquid membrane. The first layer can, for example, include a plasticized polymer. In several embodiments, the first layer includes or is formed from polyvinyl chloride, a substituted polyvinyl chloride, a cellulose triacetate, a polyurethane, a polymethacrylate or a silicone rubber. In several such embodiments, the first layer includes a plasticized polyvinyl chloride.

The sensor can also include circuitry to apply a potential to the electrically conductive material. The circuitry can, for example, be operable to apply a potential to the electrically conductive material in a first direction to cause analyte from the sample to concentrate in the first layer. The circuitry can also be operable to reverse the potential applied to the electrically conductive metal to a second direction to cause analyte to exit the first layer and reenter the sample. The circuitry can further be operable to measure a current resulting from transfer of analyte across the first surface of the first layer.

The circuitry can, for example, be operable to set the potential applied to the electrically conductive material in the first direction and vary the potential applied in the second direction to perform linear sweep or other (for example, more advanced) voltammetry as known in the art.

In several embodiments (for example, for the detection of an anion such as perchlorate or hexafluoroarsenate), the first layer includes plasticized polyvinyl chloride and the second layer includes poly(3-octylthiophene). In several other embodiments, (for example, for the detection of a cation), the first layer includes plasticized polyvinyl chloride and the second layer includes poly(3,4-ethylenedioxythiophene).

In several embodiments, the conductive polymer is poly(3-octylthiophene) and the first layer is plasticized polyvinyl chloride having a effective thickness no greater than 1 μm. In several other embodiments, the conductive polymer is poly(3,4-ethylenedioxythiophene) and the first layer is plasticized polyvinyl chloride having an effective thickness no greater than 3.25 μm.

In a number of embodiments, the second layer includes a conductive polymer having an effective thickness no greater than 1 μm.

The sensor can further include a mechanism to impart motion to the working electrode. In several embodiments, the mechanism imparts rotational motion to the working electrode.

The polymeric material of the first layer can be immiscible with the sample. For example, the polymeric material of the first layer can be immiscible with water (in the case of an aqueous sample). The first layer can further include at least one electrolyte. The first layer can further include at least one entity (for example, a receptor) to associate or interact with the analyte to facilitate transport of analyte into the first layer from the sample. The at least one entity can, for example, be a receptor that forms a complex with the analyte.

The conductive polymer of the second layer can, for example, be immiscible with the polymeric material of the first layer. In several embodiments, the conductive polymer is not reactive with the polymeric material of the first layer, with the sample or with the analyte. In a number of embodiments, the polymeric material of the first layer is immiscible with the sample and with the conductive polymer of the second layer. The polymeric material of the first layer can also be non-reactive with the conductive polymer of the second layer, with the sample or with the analyte.

In several embodiments, at least one chemical moiety, which is insoluble in the sample, is incorporated in the first layer. The chemical moiety incorporated in the first layer can, for example, be an electrolyte or an analyte receptor (that is, a chemical moiety to associate or interact with the analyte to facilitate transport of analyte into the first layer from the sample).

The sensor can further include a counter electrode and a reference electrode.

In another aspect, the present invention provides a working electrode for use in a sensor including a first layer formed of a polymeric material, wherein the first layer includes a first surface across which an analyte in a sample can be transported and a second surface generally opposite of the first surface. The first layer satisfies the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10. In several embodiments, σ is no greater than 7, 5, 2.5, or even 1. The working electrode also includes a second layer in contact with the second surface of first layer. The second layer is adapted to undergo at least one of a reduction reaction or an oxidization reaction. The working electrode further includes a support including a solid electrically conductive material in electrical connection with the second layer.

In a further aspect, the present invention provides a method of detecting an analyte in a sample, including: placing a working electrode in fluid connection with the sample; concentrating analyte in the first layer over a period of time; applying a potential to the electrically conductive material to cause analyte in the first layer to transport across the first surface into the sample; and measuring a current resulting from transport of analyte across the first surface. As described above, the working electrode preferably includes a first layer formed of a polymeric material and including a first surface across which an analyte in a sample can be transported and a second surface generally opposite of the first surface. The first layer satisfies the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10. In several embodiments, σ is no greater than 7, 5, 2.5, or even 1. The working electrode also includes a second layer in contact with the second surface of first layer. The second layer is adapted to undergo at least one of a reduction reaction or an oxidization reaction. The working electrode further includes a support including a solid electrically conductive material in electrical connection with the second layer.

Low (for example, subnanomolar) detection limits (sometimes referred to a limits of detection or LODs) were achieved using electrodes of the present invention. Indeed, the LODs achieved are believed to be the lowest LODs for ion-transfer stripping voltammetry reported to date. The solid-supported thin membranes of the present invention enable efficient preconcentration and exhaustive stripping of analyte ions, thereby lowering a LOD in comparison to LODs of a few nanomolar concentrations or higher at bulk liquid membranes.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates anion transfer (preconcentration) from an aqueous solution/sample into a working electrode of the present invention.

FIG. 1B illustrates anion transfer (stripping) from the working electrode into the aqueous solution/sample upon reversing the potential applied to the working electrode.

FIG. 2 illustrates an embodiment of an electrochemical sensor system of the present invention.

FIG. 3A illustrates perchlorate transfer from an aqueous solution/sample into a working electrode (preconcentration) of the present invention.

FIG. 3B illustrates perchlorate transfer from the working electrode (stripping) into the aqueous solution/sample upon reversing the potential applied to the working electrode.

FIG. 4A illustrates cation transfer from an aqueous solution/sample into a working electrode (preconcentration) of the present invention

FIG. 4B illustrates cation transfer from the working electrode (stripping) into the aqueous solution/sample upon reversing the potential applied to the working electrode.

FIG. 5A illustrates experimental (solid line) and simulated (circles) cyclic voltammograms of 20 μM tetrapropylammonium (TPA) with a PVC/PEDOT-modified Au electrode (scan rate, 0.1 V/s).

FIG. 5A illustrates experimental (solid line) and simulated (circles) cyclic voltammograms of 20 μM tetraethylammonium TEA with a PVC/PEDOT-modified Au electrode (scan rate, 0.1 V/s).

FIG. 6A illustrates stripping voltammograms of 25 nM TPA at 0.1 V/s after preconcentration for 5, 10, 15, 20, 30, 45, and 60 min (from the bottom), wherein the electrode was rotated at 4000 rpm.

FIG. 6B illustrates plots of (Qₛ−Q_{bg})/Q_{eq} versus tₚ, for TPA and TEA, wherein the circles and solid line represent experimental and theoretical values, respectively.

FIG. 7A illustrates background-subtracted stripping voltammograms of 1000, 500, 300, 100, 50, and 0 pM TPA in deionized water at 0.1 V/s after 30 min preconcentration, wherein the inset shows original stripping voltammograms before background subtraction (including a background stripping voltammogram), and wherein the electrode was rotated at 4000 rpm.

FIG. 7B illustrates plots of the background-subtracted peak current versus the concentrations of TPA after 3 min. and 30 min. of preconcentration, wherein the solids lines represent the best linear fits used for determination of LODs.

FIG. 8 illustrates experimental (solid line) and simulated (circles) cyclic voltammograms of 20.4 μM hexafluoroarsenate with a PVC/POT-modified Au electrode (scan rate, 0.1 V/s).

FIG. 9A illustrates stripping voltammograms of 25 nM hexafluoroarsenate at 0.1 V/s after a preconcentration step of 0.5, 1, 2, 3, 4, 6, 8, 10, 12, 15, and 20 min wherein the electrode was rotated at 4000 rpm.

FIG. 9B illustrates plots of (Qₛ−Q_{bg})/Q_{eq} versus tₚ, for hexafluoroarsenate and perchlorate, wherein the circles and solid lines represent experimental and theoretical values, respectively.

FIG. 10 illustrates stripping voltammograms of 0, 0.25, 0.5, 0.75, 1, and 1.25 nM hexafluoroarsenate (from the bottom) in 0.01 M Li₂SO₄ at 0.1 V/s, wherein the inset shows the plot of the background-subtracted peak current versus the analyte concentrations, the preconcentration time was 8 min., and the electrode was rotated at 4000 rpm.

### DETAILED DESCRIPTION OF THE INVENTION

In several embodiments of the electrochemical sensors and methods of sensing an analyte of the present invention, ion transfer occurs at the interface between the sample (for example, an aqueous sample) and an ion-selective electrode. The electrochemical sensors of the present invention are, for example, suitable for in-situ analysis of ions and moieties that can complex with ions, which are ubiquitous and important in many media, including, for example, biological and environmental media. These analyte ions and moieties do not have to be redox active.

In several representative embodiments of the present invention, a thin polymeric (for example, PVC) membrane (liquid membrane) supported upon a solid, electrically conductive electrode was used in ion-transfer voltammetry. A mechanically stable interface can be readily and reproducibly formed at the solid-supported membrane without an internal solution. A small ohmic potential drop in the thin membrane enables the voltammetric measurement at a macroscopic interface in a standard three electrode cell.

In the electrodes of the present invention, an intermediate layer was used to mediate charge transport between the ionically conductive liquid membrane and the electronically conductive solid support. For example, a conjugated, conducting polymer (such as a polypyrrole, a polythiophene and/or a polyaniline) can be used as an intermediate layer to mediate charge transport. Besides efficient charge transport, a hydrophobic, conducting polymer (such as poly(3-octylthiophene) (POT)) prevents water-layer formation at the membrane/metal interface, which assists in obtaining a stable potential.

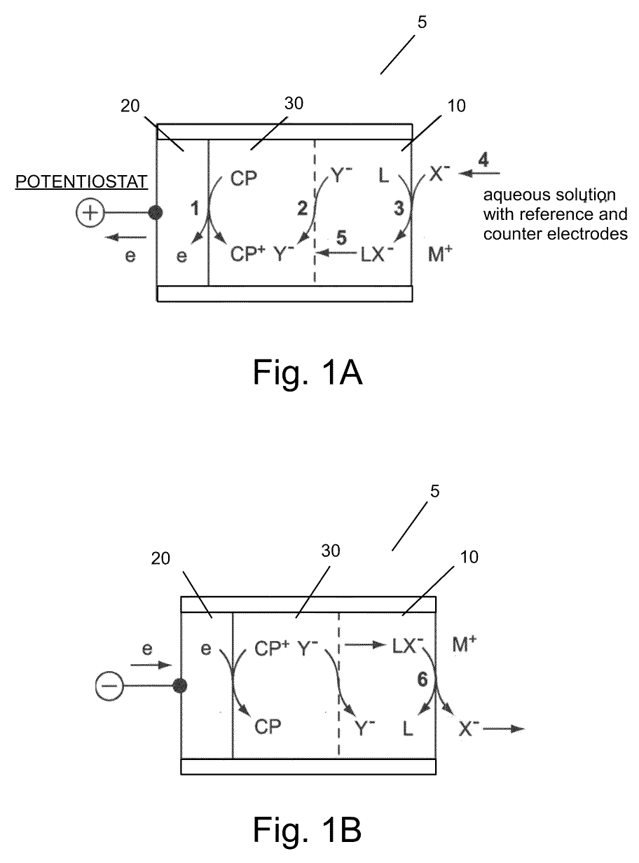

FIGS. 1A and 1B illustrates how a thin ion-selective polymer membrane 10 supported upon a solid electrode 20 allows formation of a stable and conductive liquid/liquid system for the detection of an anion analyte. FIG. 1A illustrates anion (analyte) transfer (preconcentration) into ion-selective membrane 10, while FIG. 1B illustrates the reverse transfer (stripping) with the application of anodic and cathodic potentials, respectively. In FIGS. 1A and 1B, X⁻ is analyte anion; L is a receptor for an anionic analyte; LX⁻, complex formed via interaction between the analyte anion and the receptor; CP and CP+ represent conducting polymer 30 in a reduced state and in an oxidized state, respectively; Y⁻ is an organic anion; and M⁺ is an aqueous cation. One skilled in the art appreciates that a cation analyte can be detected using, for example, a receptor for the cationic analyte, with application of a cathodic potential in the preconcentration phase and an anodic potential in the stripping phase. In the case of a cation analyte, conductive polymer 30 would be reduced from a oxidized state or form to a reduced state in the preconcentration phase. One skilled in the art also appreciates that a receptor ion need not be used for detection of certain analytes (for example, perchlorate as described further below). A neutral (uncharged) analyte can be detected, for example, when the neutral analyte can be preconcentrated in the membrane phase as a charged complex with an ionic species that can be transferred at the interface between the aqueous and membrane phases. Stripping of the preconcentrated complexes into the sample solution provides a measurable current response.

As described above, conjugated conducting polymer (CP) 30 is used as an intermediate layer to mediate charge transport between ionically conductive membrane 10 and the electronically conductive solid 20 (which are represented by processes 1 and 2 in FIG. 1A). Oxidation of conducting polymer 30 with the application of anodic electrode potentials drives receptor-facilitated anion transfer (process 3 in FIG. 1A), while cation transfer can be coupled with polymer reduction at cathodic potentials to maintain electroneutrality in the double-polymer system. The current response controlled by ion diffusion (process 4) is linear to the ion concentration and more sensitive to an ion with larger charge. Selectivity among anions (or cations) can, for example, be controlled by the selective receptor such that individual ions are transferred at different potentials. The potential of a single electrode can be externally tuned for detection of an arbitrary ion or be scanned for sequential multi-ion detection. Efficient preconcentration and diffusion of an ion in the thin ion-selective membrane (process 5) enhances a current response based on reverse ion transfer (process 6 in FIG. 1B), enabling ion-selective stripping voltammetry. Response time, spent mainly for the preconcentration step, can, for example, be controlled to readily achieve a LOD between, for example, nanomolar and picomolar ranges of an analyte concentration

The ion-selective electrodes of the present invention can, for example, also be operated in an amperometric mode. Biocompatible, ion-selective membranes (for example, PVC membranes) can be used for biological applications. Indeed, in addition to other ions, the properties of the electrodes and sensors of the present invention are well suited for monitoring biomedically important polyions such as anticoagulant/antithrombotic heparin and its antidote protamine within their narrow therapeutic concentration ranges. Applied potentials can be adjusted or optimized to minimize potential-dependent adsorption of blood proteins at the interface without decelerating ion transfer.

It is desirable that the liquid membranes of the present invention are sufficiently thin that the analyte can be exhaustively stripped from the membrane during a potential sweep (for example, at 0.1 V/s) to provide a measurable current. The modes of membrane ion diffusion are characterized by a dimensionless parameter σ, which represents the square of membrane thickness with respect to diffusion distance in the membrane as defined by

$$σ = \frac{{l}^{2} \vert {z}_{i} \vert Fv}{{D}_{m} RT} \qquad ( 1 )$$

where l is the effective membrane thickness, Dₘ is a diffusion coefficient of an analyte in the membrane phase, R is molar gas constant, T is temperature, zᵢ is a charge of the analyte (or ion-analyte complexes for a neutral analyte), F is faraday constant, and v is the rate of a potential sweep during a stripping process. Idealistic thin layer behavior will be observed in the case that σ<1. In the case of idealistic thin layer behavior, diffusion of an analyte ion in the membrane is negligible.

In general, it is desirable to minimize σ in the electrodes of the present invention. The inventors have discovered that, for example, σ values of no more than 10 provide desirable LODs. In other embodiments, σ values no greater than 7, no greater than 5, no greater than 2.5 or even no greater than 1 are achieved. One can rearrange equation 1 to solve for the membrane thickness, l, which preferably satisfies the relation l≦(σDₘRT/|zᵢ|Fv)^{1/2}, wherein σ is, for example, no greater than 10 as described above.

With a typical analyte diffusion coefficient, a typical analyte charge and a conventional rate of a potential sweep, an effective membrane thickness in the range or approximately 0.1-3.25 μm or 0.1-3.0 μm will provide the best sensitivity. In general, it has been discovered that the ion-selective membranes of the present invention are stable at such thicknesses, and the reduced thickness (and resultant reduced volume) of the ion-selective membranes of the present invention (as compared to currently available ion-selective membranes) enables accumulation of substantially higher concentrations of analyte during the preconcentration phase over relatively quick periods of time. Preconcentration into a smaller volume of the relatively thin membranes of the present invention is more efficient than preconcentration into thicker membranes. The use of shorter or similar preconcentration time than with thicker membranes results in lower detection limits with the relatively thin membranes of the present invention.

In a number of embodiments, the effective membrane thickness is in the range of approximately 0.1 to 2 μm or even in the range or 0.1 to 1 μm. In several embodiments, the thickness of the ion-selective membrane does not exceed 3.25 μm, 2 μm or even 1 μm at any point (that is, the maximum thickness of the first layer is less than 3.25 μm, 2 μm or even 1 μm).

Routine trace analysis typically requires both a relatively short response time and a low detection limit. The preconcentration time, accounts for the majority of the measurement or response time of currently available voltammetric sensor. In general, the preconcentration times of the sensors of the present invention are preferably less than 10 min and, more preferably less than 1 min.

The thicknesses of a conducting polymer film and ion-selective membrane can, for example, be readily optimized to obtain the lowest possible LODs associated with various preconcentration times. A thin conducting polymer film is also desirable for a relatively low LOD because characteristics such as surface roughness, porosity etc. of the underlying film affects the average thickness of a ion-selective membrane. At the same time, the film must be sufficiently thick to efficiently sustain a current flow. Moreover, at some thickness, leaching of the ion-selective membrane components into the aqueous phase can limit the longevity of the thin ionic-selective membrane. Ion-selective membrane thickness and sensor lifetime can be readily optimized via application of known principles in routine experimentation. Sensor lifetime can, for example, be determined by repeated measurement until the loss of membrane components deteriorates the LOD. In several embodiments, conductive polymer layers of the present invention have an effective thickness no greater than 2 μm, no greater than 1.5 μm or even no greater than 1 μm. In a number of embodiments, the effective thickness of the conductive polymer is in the range or approximately 0.3 to 1 μm.

In several representative studies of the present invention, a sensor including working electrodes including a thin poly(vinyl chloride) (PVC) membrane supported upon a poly(3-octylthiophene)- or POT-modified gold electrode were used to sense perchlorate (ClO₄⁻). A THF-insoluble, neutral POT film can, for example, be deposited by cyclic voltammetry on a gold electrode. A thin PVC membrane (for example, no greater than 1 μm in thickness) can then be spin-coated on the POT film directly from a THF solution of the PVC membrane components without mixing the two phases. In the case of a POT conductive polymer layer, the ion-selective membrane layer of the electrodes (for example, PVC) can, for example, be no greater than 1 m, no greater than 0.7 μm or even no greater than 0.5 μm in effective thickness. POT was found to be a good conducting polymer for voltammetric anion detection. Stripping voltammetry with the solid-supported ion-selective electrodes of the present invention provided LODs of 0.2-0.5 nM for perchlorate in deionized water, commercial bottled water, and tap water. In contrast to conventional stripping voltammetry based on a redox reaction of an analyte at a mercury or a solid electrode, ion-transfer stripping voltammetry enables the detection of perchlorate without its electrolysis.

To achieve nanomolar or lower perchlorate detection within 10 min, a working electrode for the studies of the present invention was rotated using a 5 mm-diameter gold disk attached to a rotating disk electrode tip as the solid support (available from Pine Research Instrumentation of Raleigh, N.C.). As more fully described in the Experimental Section hereof, poly(3-octylthiophene) film (which is not readily soluble in THF during spin-coating of a PVC membrane) was deposited on the polished gold electrode by cyclic voltammetry A PVC membrane was then spin-coated on a 5 mm-diameter gold disk modified with a POT film.

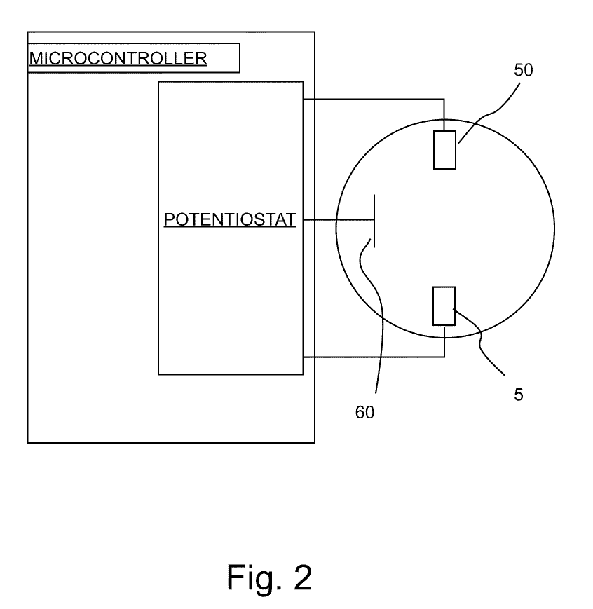

In several studies, a CH Instruments 600A electrochemical workstation was used for voltammetric measurements with the solid-supported ISEs. A three-electrode arrangement as illustrated in FIG. 2 with a Ag/AgCl reference electrode 50 (available from CH Instruments) and a Pt-wire counter electrode 60 was employed used in connection with a working electrode 5 of as described in FIGS. 1A and 1B. The electrochemical cells are represented as follows:

Ag|AgCl|KCl (sat)∥x M LiClO₄ in 0.1 M LiSO₄ (aq)|PVC membrane|POT|Au

Aqueous sample solutions of various perchlorate concentration were prepared with 18.3 MΩcm deionized water (available from Nanopure, Barnstead of Dubuque, Iowa), tap water, or commercial bottled water. The tap water sample was collected from the cold water tap of a laboratory sink after the water was allowed to run for 15 min.

The current carried by a positive charge from the aqueous phase to the PVC membrane was defined to be positive. All electrochemical experiments were performed at 22±3° C. A piece of Teflon tube was placed on the modified gold electrode tip in cyclic voltammetric experiments to obtain a disk-shaped PVC membrane/water interface with the diameter of 1.5 mm and the interfacial area of 0.0177 cm². The tube was not used for cyclic voltammetry or stripping voltammetry under rotating electrode configuration with a modulated speed rotator (available from Pine Research Instrumentation of Raleigh, N.C.).

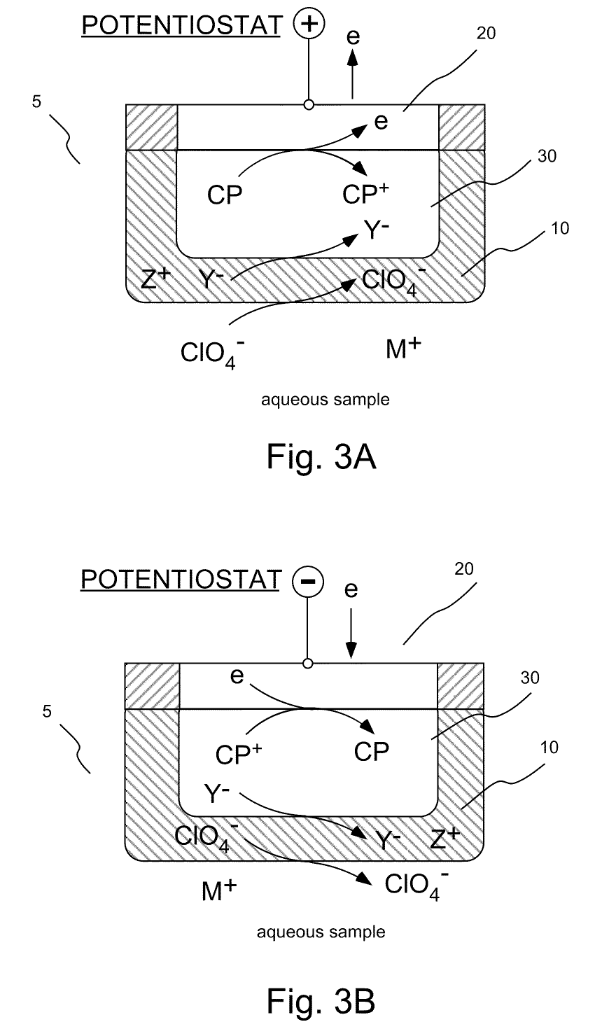

The POT film mediated efficient charge transport between PVC membrane 10 and gold electrode 20 (processes 1 and 2 in FIG. 1A) as demonstrated by cyclic voltammetry. In the characterization of a POT film for conducting polymer layer 30, tetrabuthylammonium perchlorate from the aqueous sample phase partitions between the two phases to sustain a current flow at the nonpolarizable membrane/water interface with maintenance of a constant distribution potential. The current response is thus controlled by charge transport through POT film 30 confined to gold electrode 20. The anodic and cathodic peak potentials were independent of scan rate. This result indicates that an ohmic potential drop was negligible and that charge transport through the PVC-covered POT film was electrochemically reversible. The current response was found to be stable for repeated potential cycling. It was also demonstrated that POT film 30 was in the reduced form at equilibrium or steady state. A neutral POT film is suitable for coupling anion transfers, where the film is initially in the reduced form and then in the oxidized form (see FIGS. 1A and 3A).

In several studies, the stripping measurement was performed in a rotating-electrode configuration to control and enhance ion flux to the interface during preconcentration step. In that regard, rotation of the electrode creates hydrodynamic flow of a sample solution to the electrode surface so that an analyte is brought to the surface efficiently. A similar hydrodynamic effect can, for example, be achieved by stirring the sample solution or by otherwise causing the sample solution to flow over the electrode surface.

Solid-supported ion-selective electrode 5 was characterized by studying fast, reversible perchlorate transfer. A polarizable liquid membrane/water interface was formed by immersing a modified electrode in an aqueous electrolyte solution of LiClO₄. No ion is transferred across the interface at equilibrium. With an anodic potential sweep, perchlorate was transferred into bulk PVC membrane 10 without a receptor (see FIG. 3A). A liquid membrane without receptor demonstrated a high perchlorate selectivity based on the Hofmeister series, e.g., ClO₄⁻>SCN⁻>I⁻>NO₃⁻>Br⁻>Cl⁻. The reverse transfer was observed with a successive cathodic scan (see FIG. 3B). The potential drop at the liquid membrane/water interface can be controlled accurately enough to obtain well-defined voltammetric features. Stripping voltammetry gave a linear current response to the perchlorate concentration down to 0.2-0.5 nM. That LOD is lower than that of potentiometric perchlorate-selective electrodes (18 nM) and the current Environmental Protection Agency action limit (250 nM) in drinking water.

In that regard, public concern about perchlorate in the environment has steadily increased in recent years. Besides its natural existence, perchlorate is used as an oxidant in solid rocket fuel, matches, fireworks, automobile airbag-inflation systems, and a variety of other industrial applications, including the production of dyes, paints, and rubber. Trace perchlorate (1-100 ppb) has been detected in drinking water, human and cow's milk, and produce. Potential health effects associated with perchlorate include disruption of the thyroid function by competitive inhibition of iodide transport. The resulting reduction of thyroid hormone production can impair the gland development as seen in conditions of hypothyroidism or hypothyroxinemia. Pregnant women, children, and people with compromised thyroid function are particularly at risk. The EPA action limit for aqueous perchlorate in drinking water was set to 24.5 ppb (250 nM) in 2005. There, however, has been the debate over what exposure level of perchlorate is safe, partially because human exposure to perchlorate has not been quantified. The sensors and methods of the present invention provide a simple and portable analytical method for quantification of that exposure.

As described further below, a LOD of 90±20 pM for hexafluoroarsenate, which is another environmental contaminant, was obtained with sensors of the present invention. In general, and as further described below, the subnanomolar LODs of 0.2-0.5 nM achieved for perchlorate with the sensors of the present invention can be lowered to LODs in, for example, the picomolar range for more lipophilic ions such as hexafluoroarsenate, and also for ions that can be transferred into the membrane more preferentially by complexation with ionophores

As discussed above, the sensors of the present invention are suitable to detect a wide variety of analytes including, for example, biomedically important polyions. Chemical analysis of biological polyions is highly significant, because of their wide use in many fields. Two important examples in medicine are heparin and its antidote protamine. Heparin, a highly sulfated polysaccharide (with an average charge of approximately −75), is used for prevention of blood clotting in many medical procedures (approximately 12 million surgeries annually in the United States and 36 million worldwide). Heparin is potentially of clinical use beyond anticoagulation (for example, as an anti-inflammatory and antineoplastic) because of its ability to bind with a variety of proteins. Among prescribed natural pharmaceuticals, heparin is second in use only to insulin and currently grosses $3 billion per year in sales. Low-molecular-weight heparin (LMWH) is derived from heparin by chemical or enzymatic depolymerization. Because of its much better efficacy/safety ratio, LMWH has gradually replaced heparin for many indications. The anticoagulant activity of heparin and LMWH is neutralized by protamine, a naturally occurring polycationic protein rich in arginine (with a charge of approximately +20).

Successful applications of a chemical sensor require high selectivity. An ion-selective membrane (for example, a PVC membrane) can, for example, be doped with a receptor for heparin (or another analyte) such as octadecyltrimethylammonium. Hydrogen-bonding receptors with a guanidinium unit to selectively recognize an anionic group of heparin and LMWHs can also be used. The hydrogen-bonded ion-paring that mimics heparin-protein interactions can be stronger and more specific than the quaternary ammonium-anion pairing used in previous heparin sensors. Many guanidinium-based receptors have been developed for selective oxoanion recognition. Simple receptors with one guanidinium unit, for example, provide excellent selectivity for hydrogen sulfate and salicylate with PVC membranes. Several structures of hydrogen-bond-mediated complexes of an oxoanionic group of heparin (X=C or SO) with guanidinium- and ammonium-based receptors, 1-4 are illustrated below.

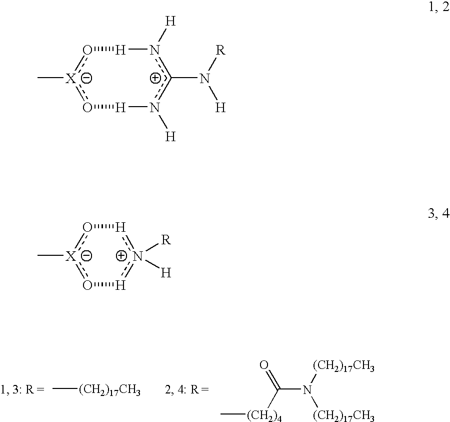

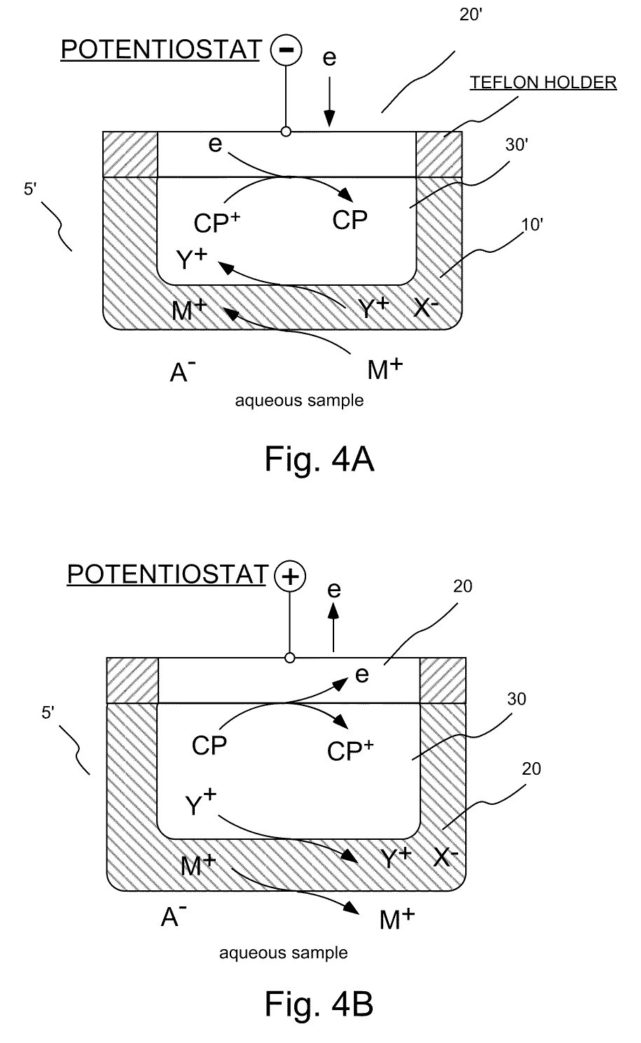

As, for example, illustrated in FIGS. 4A and 4B, voltammetric cation detection requires a stable and reducible conducting polymer. The POT film described above is not appropriate for cation detection. In that regard, a POT film is unstable in the oxidized form and is not reducible in the neutral form. Cation detection can be effected using, for example, poly(3,4-ethylenedioxythiophene) (PEDOT). In contrast to POT, PEDOT is stable and reducible in its oxidized form. FIG. 4A illustrated reduction of a conductive polymer 30′ from its oxidized form to its neutral form during preconcentration of a cationic analyte, while FIG. 4B illustrates oxidation of neutral conductive polymer 30′ to its oxidized from during stripping. The charge transport through a PEDOT film is fast in many organic solvents. A solid electrode 10′ can be modified with an oxidized PEDOT film 30′ (which can, for example, be doped with tetrakis(pentafluorophenyl)borate). A THF-insoluble PEDOT film, for example, allows for directly spin-coating of thin PVC membrane 10′ thereover as described above. A PEDOT film adheres to PVC membrane 10′ and the supporting solid electrode 20′ tightly to hinder formation of a water layer.

Cation-selective electrodes such as electrode 5′ of FIGS. 4A and 4B can, for example, be applied to detect an analyte such as polycationic protamine. A PVC membrane can, for example, be doped with a tetradodecylammonium salt of dinonylnaphthalene sulfonate, which serves as a negatively charged protamine receptor.

Simultaneous multi-analyte detection in biological and environmental samples is attractive but usually requires chemical sensor arrays. In contrast, a single voltammetric ion-selective electrode of the present invention can be suitable to detect multiple analytes.

Multi-ion detection with a single voltammetric ion-selective electrode of the present invention requires high ion selectivity, which can, for example, be obtained using receptors developed for potentiometric ion-selective electrodes. Commercially available cation-selective receptors give more than 10⁴ time selectivity, e.g., valinomycin for K⁺ over Na⁺ and ETH 1001 for Ca²⁺ over Mg²⁺. Ion selectivity is also improved by the thinness of the ion-selective membranes of the present invention. Negligible mass transfer of small ions in the thin membrane results in a sharp and symmetric stripping peak based on thin-layer behavior. The peak half-width is given by 75/z mV at 25° C. for reversible ion transfer, where z is the ionic charge. The 104 time selectivity corresponds to a difference in the peak potentials of 237/z mV at 25° C. The peak separation is sufficiently larger than the peak width to enable detection of two ions. This principle is applicable for detection of three or more ions, if the ions are transferred at sufficiently different potentials.

Cation-selective electrodes can, for example, be fabricated based on PEDOT films and a variety of neutral receptors for heavy metals. The receptor can be simply added to an thin PVC membrane of the present invention including tetradodecylammonium tetrakis(pentafluorophenyl)borate as a supporting electrolyte. Anions can be also detected using selective receptors.

Voltammetric detection of cationic analytes was demonstrated by introducing an oxidatively doped PEDOT film, which has a high stability and undergoes a facile redox reaction. In several experiments, a LOD of tetrapropylammonium (TPA) was compared with that of less lipophilic tetraethylammonium (TEA). The studies demonstrated that a more lipophilic analyte ion gives a lower LOD for ion-transfer stripping voltammetry with a solid-supported thin liquid membrane. Different lipophilicities of the cations were measured as formal ion-transfer potentials by cyclic voltammetry and stripping voltammetry. Further, a PVC/POT-modified Au electrode was employed to determine a LOD of a lipophilic anion, hexafluoroarsenate, which is known as one of arsenical biocides and was recently found in wastewater. Subnanomolar LODs were achieved for both cationic and anionic analytes.

The studies of the present invention confirm a theoretical prediction that a more lipophilic ion gives a lower LOD for ion-transfer stripping voltammetry with a solid-supported thin liquid membrane. When an aqueous ion is preconcentrated into the thin membrane, equilibrium partitioning of the analyte ion between the bulk aqueous and membrane phases is eventually achieved to limit a membrane concentration of the analyte ion. The equilibrium membrane concentration of the analyte ion, cₘ, with respect to its sample concentration, c_{w}, is determined by the Nernst equation as

$$\frac{{c}_{m}}{{c}_{w}} = exp [ - \frac{{z}_{i} F ( {Δ}_{w}^{PVC} {φ}_{p} - {Δ}_{w}^{PVC} {φ}^{{0}^{′}} )}{2.303 RT} ] \qquad ( 2 )$$

where zᵢ is the charge of the analyte ion, F is Faraday's constant, Δ_{w}^{PVC}φₚ is the Galvani potential difference between the aqueous and membrane phases applied during a preconcentration step, and Δ_{w}^{PVC}φ^{0′} is the formal potential of the analyte ion. A more lipophilic cation (or anion) has a more positive (or negative) formal potential, thereby yielding a higher membrane concentration with respect to a given sample concentration. Since the amplitude of a stripping current response varies with the membrane concentration, higher sensitivity and subsequently a lower LOD are expected for a more lipophilic ion. This principle is confirmed experimentally in the present studies for cationic analytes with different lipophilicities and then applied for detection of an anionic analyte other than perchlorate. Equation 2 also predicts that a higher membrane concentration and subsequently a lower LOD are expected for an ion with larger charge as well as an ion that binds to an ionophore molecule in the membrane, i.e., an ion with a more favorable formal potential.

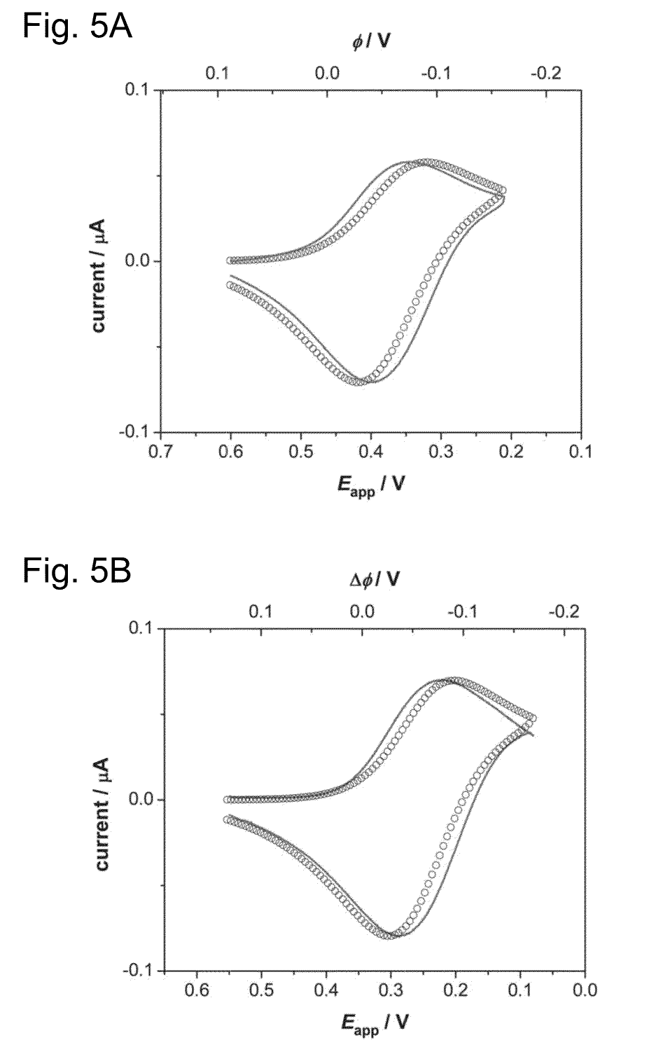

Once again, tetraalkylammoniums with different alkyl groups (that is, TPA and TEA) were employed as model cationic analytes with different lipophilicities. Well-defined cyclic voltammograms (CVs) of TPA and TEA were obtained at a PVC/PEDOT-modified electrode (solid lines in FIGS. 5A and 5B, respectively). A peak-shaped cathodic wave based on transfer of either ion from the aqueous phase into the membrane phase is coupled with reduction of the underlying PEDOT film in the oxidized form. The reverse cation transfer during the anodic potential sweep also gives a peak current response, which requires oxidation of the reduced PEDOT film. The more lipophilic TPA is transferred more favorably from the aqueous phase into the membrane phase, thereby yielding the corresponding CV at less cathodic potentials.

Lipophilicities of the tetraalkylammoniums were quantitatively determined as formal ion-transfer potentials, Δ_{w}^{PVC}φ^{0′}, from the corresponding CVs, which were numerically analyzed by employing the finite element method. The experimental CVs were fitted with CVs simulated for reversible transfer of a monocation at a PVC/PEDOT-modified electrode (black circles in FIGS. 5A and 5B). The best fits show that the difference in lipophilicities of TPA and TEA corresponds to the difference of 70 mV in their formal ion-transfer potentials. In this analysis, the potential applied to the Au electrode, Eₐₚₚ, was converted to the potential applied at the PVC membrane/water interface, Δ_{w}^{PVC}φ (indicated on the top axis of FIGS. 5A and 5B) by considering the polarization of a PVC/PEDOT/Au junction. This polarization is likely the origin of the deviation between the experimental and simulated CVs. This deviation is not a result of an Ohmic potential drop in the membrane, which is sufficiently conductive as confirmed by electrochemical impedance spectroscopy.

The CVs of TPA and TEA also demonstrate that the solid-supported membrane is thin enough for these tetraalkylammoniums to be exhaustively stripped from the membrane during the anodic potential sweep at 0.1 V/s. In fact, the total charge under the cathodic response in the CVs is nearly cancelled by the total charge under the anodic response. Moreover, the resulting anodic peak current enhanced by efficient ion diffusion in the thin membrane is larger than the cathodic peak current in contrast to the corresponding peak currents for semi-infinite ion diffusion in a thick membrane. As described above, the modes of membrane ion diffusion are characterized by a dimensionless parameter σ in Equation 1. The numerical analysis of the experimental CVs in FIGS. 5A and 5B gives σ values of 6.3 and 4.7, respectively, which are much smaller than a σ value of >100 for semi-infinite ion diffusion. These σ values of TPA and TEA, however, are larger than required for an idealistic thin layer behavior (σ<1), where diffusion of an analyte ion in the membrane is negligible. The intermediate σ values of a PVC/PEDOT-modified electrode are a result of the thickness of the PVC ion-selective membrane layer required to cover the relatively porous PEDOT layer. In general, the PVC maximum effective thickness was thicker than 3 μm to completely cover a PEDOT film. In general, the PVC layer extends into the pores of the PEDOT layer, effectively increasing the thickness of the PVC layer in the location of such pores.

Equation 2 predicts that more lipophilic TPA, with a less cathodic formal potential, can be preconcentrated at a higher membrane concentration with respect to its sample concentration. This lipophilicity dependence was proved by measuring stripping voltammograms of TPA and TEA at different preconcentration times.

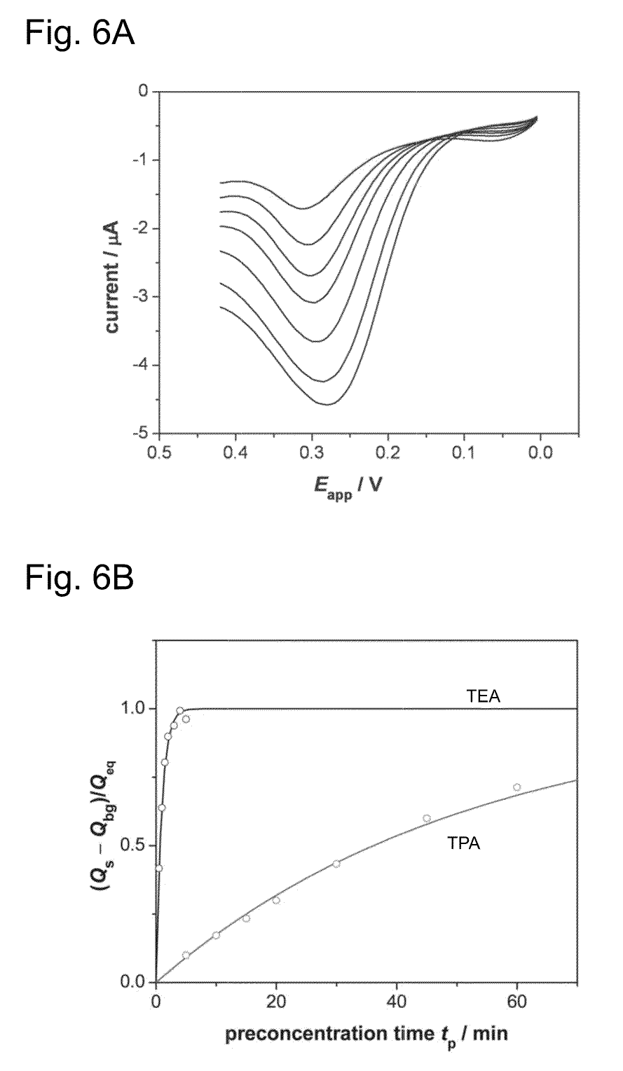

Stripping voltammograms of 25 nM TPA demonstrate that the anodic stripping response varies with preconcentration time even after 1 hour (FIG. 6A). On the other hand, a stripping response to TEA reaches a plateau only after 2 min preconcentration when equilibrium partitioning of TEA between the membrane and aqueous phases is achieved (data not shown).

The different time profiles for preconcentration of TPA and TEA are quantitatively ascribed to their different lipophilicities. Dependence of the charge under a stripping voltammogram, Qₛ, on the preconcentration time, tₚ, agrees very well with

$${Q}_{s} = {Q}_{eq} ⌊ 1 - exp ( - \frac{{i}_{1}}{{Q}_{eq}} {t}_{p} ) ⌋ + {Q}_{bg} \qquad ( 3 )$$

where Q_{eq} is the charge of preconcentrated ions at an equilibrium, i₁ is the limiting current at the rotating electrode, and Q_{bg} is the charge based on background current. The good agreements for both TPA and TEA are shown in normalized plots of (Qₛ−Q_{bg})/Q_{eq} versus tₚ in FIG. 6B, thereby yielding Q_{eq}, Q_{bg}, and i₁ values. This analysis demonstrates that the membrane concentration of TPA after 1 hr preconcentration reaches to 70% of the equilibrium concentration. Q_{eq} is related to a formal ion-transfer potential as given by

$${Q}_{eq} = {z}_{i} {FAlc}_{w} exp [ - \frac{{z}_{i} F ( {Δ}_{w}^{PVC} {φ}_{p} - {Δ}_{w}^{PVC} {φ}^{{0}^{′}} )}{2.303 RT} ] \qquad ( 4 )$$

The Q_{eq} values thus determined for TPA and TEA correspond to overpotentials of Δ_{w}^{PVS}φₚ−Δ_{w}^{PVC}φ^{0′}=0.31±0.01 and 0.23±0.01 V, respectively, in equation 4 with l=3 μm. Since the same potential was applied for preconcentration of both TPA and TEA, the different overpotentials correspond to the difference of 80±10 mV in formal potentials of the two ions. This result agrees well with the difference of the formal potentials determined by cyclic voltammetry (see above). Equation 2, with these overpotentials, gives the equilibrium membrane concentrations of TPA and TEA that are greater than the sample concentration by factors of (1.6±0.7)×10⁵ and (1.0±0.4)×10⁴, respectively, at the preconcentration potential. This result indicates that a PVC membrane has 16 times higher capacity for more lipophilic TPA. In contrast, Q_{bg} values of 3.0 and 4.2 μC determined for TPA and TEA, respectively, reflect the difference in the background voltammograms. Moreover, the i₁ values of 21 and 4.4 for the respective ions agree with the Levich equation, indicating that the difference in i₁ values is simply a result of different aqueous concentrations and diffusion coefficients of the ions.

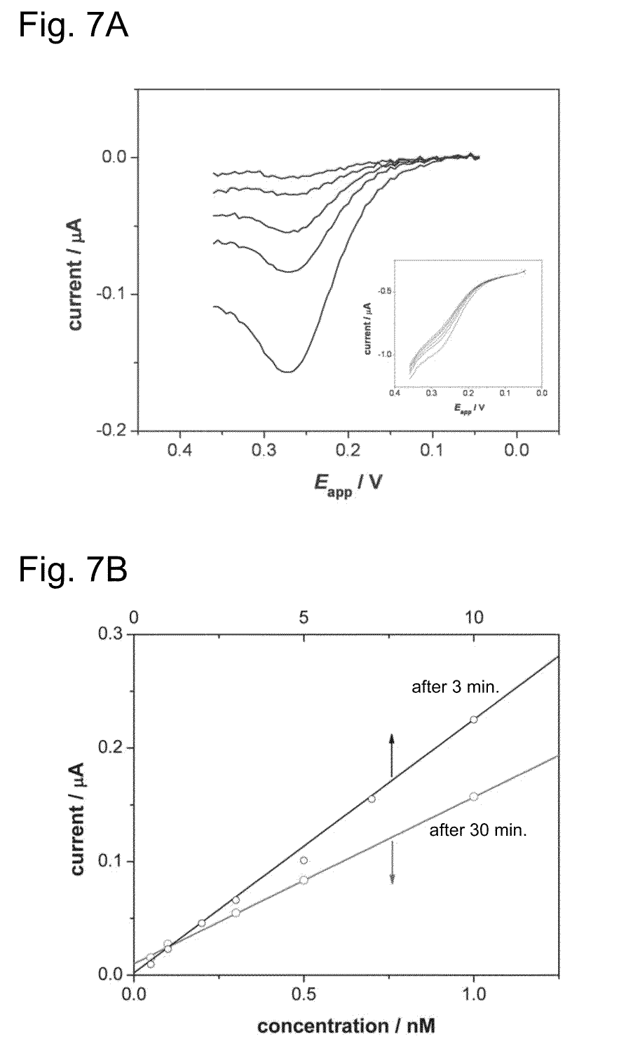

Stripping voltammetry with a PVC/PEDOT-modified electrode was found to provide a subnanomolar LOD for TPA after 30 minute preconcentration. Stripping current responses to TPA vary with its concentrations in the range of 50-1000 pM (FIG. 7A). The IUPAC's upper limit approach was employed to obtain a LOD of 80±40 pM TPA (at a confidence level of 95%) from a linear relationship between the stripping peak current and TPA concentration (FIG. 7B). See Mocak, J.; Bond, A. M.; Mitchell, S.; Scollary, G. Pure and Applied Chemistry 1997, 69, 297-328. This LOD is believed to be the lowest value reported to date for ion-transfer stripping voltammetry. The LOD for TPA is not significantly lowered by increasing the preconcentration time from 30 min, at which the concentration of TPA in the membrane reaches to 43% of the equilibrium concentration (FIG. 6B). A higher LOD of 0.44 nM TPA was obtained by reducing preconcentration time to 3 min (FIG. 7B). In contrast, a stripping peak current varies linearly with TEA concentrations only at >0.5 nM after either 3 or 30 min preconcentration, thereby yielding LODs of 0.37 and 0.42 nM, respectively. A PVC membrane is saturated with TEA after ˜4 min preconcentration (FIG. 6B) so that longer preconcentration does not increase the membrane concentration of TEA or, subsequently. lower the LOD. Overall, the lower LOD of 80 pM TPA in comparison to the LODs of TEA is consistent with higher lipophilicity of TPA as expected from equation 2.

In addition to studies of the effects of lipophilicity with TEA and TPA, hexafluoroarsenate was investigated as one of the most lipophilic inorganic anions in the so-called Hofmeister series to demonstrate that a lower LOD is obtained also for a more lipophilic anion. Hexafluoroarsenate is an arsenical biocide, which is also known as a pesticide, Hexaflurate. Hexafluoroarsenate was recently found in wastewater from a crystal glass factory containing high concentrations of arsenic and fluoride.

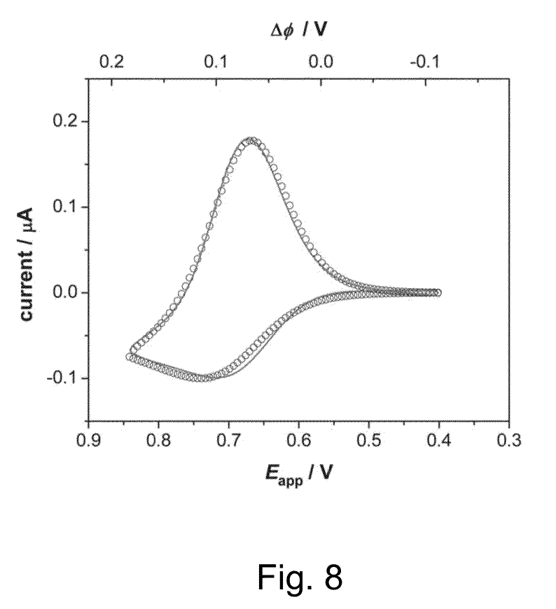

A well-defined CV of hexafluoroarsenate was obtained with a PVC/POT-modified electrode (FIG. 8). The CV fits very well with a CV simulated for reversible anion transfer with σ<1, which indicates that the solid-supported membrane serves as a thin-layer cell. This σ value for hexafluoroarsenate with a PVC/POT-modified electrode is smaller than σ values obtained for TEA and TPA with a PVC/PEDOT modified electrode, because a PVC membrane of the former electrode is thinner than that of the latter (0.7 and 3 μm in thickness, respectively). The numerical analysis of the CV of hexafluoroarsenate also demonstrates that the formal potential of hexafluoroarsenate is 102 mV less anodic than that of perchlorate, thereby indicating that hexafluoroarsenate is more lipophilic than perchlorate.

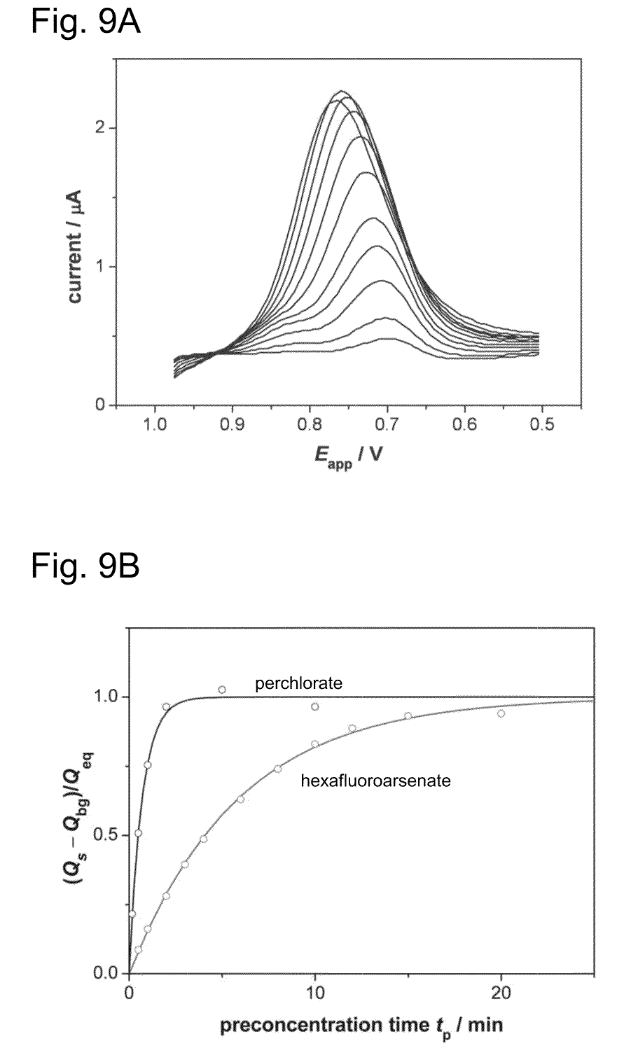

The higher lipophilicity of hexafluoroarsenate is confirmed by stripping voltammetry of 25 nM hexafluoroarsenate at various preconcentration times (FIG. 9A). The stripping current response increases monotonically at longer preconcentration times to reach to a plateau value with 20 min preconcentration when equilibrium partitioning of hexafluoroarsenate between the membrane and aqueous phases is achieved. The preconcentration time required for equilibration is 10 times longer than that for perchlorate. The slower saturation with hexafluoroarsenate is a result of its higher lipophilicity. A plot of (Qₛ−Q_{bg})/Q_{eq} versus tₚ for hexafluoroarsenate fits well with equation 3 with Q_{eq}=2.3±0.3 μC (FIG. 9B), which corresponds to an overpotential of 0.31 V in equation 4 with l=0.7 μm. This overpotential is more positive than the overpotential of 0.25 V for perchlorate. The difference in the overpotentials is consistent with the difference in formal potentials of hexafluoroarsenate and perchlorate as determined by cyclic voltammetry. It should be noted that, despite similar overpotentials, a thinner PVC membrane covered on a POT-modified electrode is more quickly saturated with hexafluoroarsenate than a PVC/PEDOT membrane with TPA.

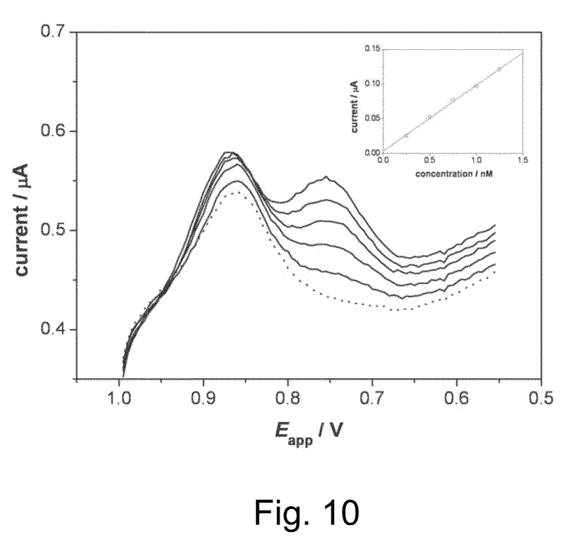

A LOD of hexafluoroarsenate in deionized water containing 10 mM Li₂SO₄ was determined by stripping voltammetry with a PVC/POT-modified electrode. Stripping current responses after 8 min preconcentration vary with 0.25-1.25 nM hexafluoroarsenate (FIG. 10). The background-subtracted peak current is linear to the sample ion concentration (inset of FIG. 10). A LOD of 90±20 pM was obtained by using the IUPAC's upper limit approach at a confidence level of 95%. This LOD is comparable to the lowest LOD of 80 pM hexafluoroarsenate (6 ng/L as arsenic) in waters as recently obtained by inductively coupled plasma-mass spectrometry with anion-exchange chromatography. Mocak, J.; Bond, A. M.; Mitchell, S.; Scollary, G. Pure Appl. Chem. 1997, 69, 297-328. Moreover, the LOD for hexafluoroarsenate with a PVC/POT-modified electrode in 0.1 M Li₂SO₄ is significantly lower than the corresponding LOD of 0.5±0.1 nM perchlorate. This result is expected from equation 2 for more lipophilic hexafluoroarsenate. In fact, the higher lipophilicity of hexafluoroarsenate is shown also in the stripping voltammograms, where the background peak current responses around ˜0.85 V (FIG. 10) may be a result of perchlorate contaminated in the membrane during electrochemical deposition of a POT film in 0.5 M LiClO₄.

The greater sensitivity for a more lipophilic ion demonstrated herein can, for example, be significant because high lipophilicity of an ion is relevant to its bioaccumulation and toxicity. Hexafluoroarsenate and perchlorate are two of the most lipophilic inorganic anions in the Hofmeister series. Perfluoroalkyl carboxylate and sulfonate, which are an emerging class of organic contaminants, are, for example, much more lipophilic than their alkyl counterparts. Other lipophilic ions that potentially possess adverse health effects include ionizable pharmaceuticals and ionic liquids.

In contrast to anionic analytes, many ionophores with high selectivity among cations have been developed for potentiometry. See, for example, Umezawa, Y.; Bühlmann, P.; Umezawa, K.; Tohda, K.; Amemiya, S. Pure Appl. Chem. 2000, 72, 1851-2082. These highly selective ionophores can significantly widen the range of applications of ion-transfer stripping voltammetry with, for example, a PVC/PEDOT-modified electrode.

The ion-selective stripping voltammetry methods of the present invention enable trace analysis of a variety of analytes in biological and environmental systems. In addition to the capability of detection of redox-inactive ions, the biocompatible and robust polymerized membranes of the sensors of the present invention provide attractive candidates for replacement of classical stripping voltammetry with mercury electrodes. As used herein, the term “biocompatible” refers generally to compatibility with living tissue or a living system. Also, ion transfer at the biocompatible membrane/sample solution should be sufficiently fast even in the biological media.

Miniaturization of the double-polymer, solid-supported electrode systems of the present invention can, for example, provide an ion-selective ultramicroelectrode for use, for example, as a probe in scanning electrochemical microscopy SECM. The ion-selective double-polymer systems of the present invention can be also prepared on a metal electrode integrated in microfluidic devices.

Experimental Section

Chemicals. Tetradodecylammonium (TDDA) bromide, 3-octylthiophene, 3,4-ethylenedioxythiophene, tetrapropylammonium chloride, lithium sulfate monohydrate, and lithium hexafluoroarsenate (V) were obtained from Aldrich (Milwaukee, Wis.). Poly(vinyl chloride) (PVC, high molecular weight), tetraethylammonium chloride, and 2-nitrophenyl octyl ether (oNPOE) were from Fluka (Milwaukee, Wis.). Potassium tetrakis(pentafluorophenyl)borate (TFAB) was from Boulder Scientific Company (Mead, Colo.). All reagents were used as received. TDDA-TFAB was prepared as reported in

1. Electrode Modification. PVC/POT. A 5 mm-diameter gold disk attached to a rotating disk electrode tip (Pine Research Instrumentation, Raleigh, N.C.) was chemically modified as follows. A gold electrode was polished over polishing cloths containing dispersions of alumina 0.3 and 0.05 μm (Buehler, Lake Bluff, Ill.) in water, and cleaned by ultrasonication in concentrated dichromic acid and then in water for 15 min three times. A poly(3-octylthiophene) film that is not readily soluble in THF during spin-coating of a PVC membrane was deposited on the polished electrode by cyclic voltammetry²⁶ using a three-electrode cell with a Ag/Ag⁺ reference electrode (CH Instruments or CHI) and a Pt-wire counter electrode. The film deposition was conducted in an acetonitrile solution containing 0.1 M 3-octylthiophene and 0.5 M LiClO₄ by repeatedly cycling the potential between 0 and 1.22 V at 0.1 V/s for 3 times using a computer-controlled CHI 600A electrochemical workstation (CH Instruments). The final potential was set to 0 V to obtain a neutral POT film. The modified gold electrode was soaked in acetonitrile for 30 min and then in THF for 1 min to remove a soluble fraction of the POT film. The thickness of a conducting polymer film can be controlled, for example, by changing the monomer concentration and/or the deposition time (that is, the number and rate of potential cycling.

A PVC membrane was spin-coated on a 5 mm-diameter gold disk modified with a POT film. A 30 μL membrane cocktail with the composition of 4 mg PVC, 16 mg o-NPOE, and 2.2 mg TDDATFAB in 1 mL THF was injected onto the gold disk rotating at 1500 rpm in a spin-coating device (model SCS-G3-8, Cookson Electronics, Providence, R1). The modified gold disk was removed from the spin coater and dried in air for 30 min. The thickness of the PVC membrane, can, for example, be controlled by adjusting the spin rate and the concentration of the membrane components.

2. Electrode Modification. PVC-PEDOT and PVC-POT. A 5 mm-diameter Au disk attached to a rotating disk electrode tip (Pine Research Instrumentation, Raleigh, N.C.) was modified with a conducting polymer film and then with a PVC membrane in a similar manner as described above for a PVC/POT-modified Au electrode.

A PEDOT film was deposited on a polished and cleaned Au electrode¹⁸ by cyclic voltammetry using a three-electrode cell with a Ag/Ag⁺ reference electrode (CH Instruments) and a Pt-wire counter electrode. The film deposition was conducted in an acetonitrile solution containing 0.01 M 3,4-ethylenedioxythiophene and 0.01 M TDDATFAB by cycling the potential between −1 and 1.4 V at 0.1 V/s for 3 times using a computer-controlled CHI 600a electrochemical workstation (CH Instruments). The final potential was set to 0.5 V to oxidatively dope a PEDOT film with TFAB. The modified Au electrode was soaked in acetonitrile for 30 min and washed with THF for 1 min to remove a soluble fraction of the PEDOT film. The remaining PEDOT film is not readily soluble in THF, thereby allowing for spin-coating of a PVC membrane from a THF solution of membrane components.

A PVC membrane was spin-coated on a 5 mm-diameter Au disk modified with a PEDOT film. A 8 μL membrane cocktail with the composition of 4 mg PVC, 16 mg o-NPOE, and 2.2 mg TDDATFAB in 1 mL THF was injected onto the PEDOT-modified Au disk rotating at 300 rpm in a spin-coating device (model SCS-G3-8, Cookson Electronics, Providence, R.I.). The slow rotation resulted in a relatively thick PVC membrane with ˜3 μm thickness, which was required for a good coverage of a PEDOT film. After spinning for \ddot{3} s, the modified Au disk was removed from the spin coater and dried in air for >30 min. A membrane cocktail with the same composition was employed to spin-coat a ˜0.7 μm-thick PVC membrane on a POT-modified Au electrode rotating at 1500 rpm.

3. Electrochemical Measurement. Perchlorate. In the case of studies perchlorate with a PVC/POT-modified Au electrodes, a CHI 600A electrochemical workstation was used for voltammetric measurements with the solid-supported ISEs. A three-electrode arrangement with a Ag/AgCl reference electrode (CH Instruments) and a Pt-wire counter electrode was employed. Electrochemical cells are as follows:

Ag|AgCl|KCl (3 M)∥x M LiClO₄ in 0.1 M LiSO₄ (aq)|PVC membrane|POT|Au

Aqueous sample solutions were prepared with 18.3 MΩcm deionized water (Nanopure, Bamstead, Dubuque, Iowa), tap water, or commercial bottled water. The tap water sample was collected from the cold water tap of a laboratory sink after the water was allowed to run for 15 min.

The current carried by a positive charge from the aqueous phase to the PVC membrane is defined to be positive. All electrochemical experiments were performed at 22±3° C. A piece of Teflon tube was put on the modified gold electrode tip for cyclic voltammetry under a stationary condition to obtain a disk-shaped PVC membrane/water interface with the diameter of 1.5 mm and the interfacial area of 0.0177 cm². The tube was not used for cyclic voltammetry or stripping voltammetry when an electrode was rotated by using a modulated speed rotator (Pine Research Instrumentation).

4. Electrochemical Measurement. Tetrapropylammonium, tetraethylammonium and hexafluoroarsenate. In the case of studies of tetrapropylammonium (TPA) and tetraethylammonium (TEA) using PVC/PEDOT-modified Au electrodes as well as studies of hexafluoroarsenate using PVC/POT-modified Au electrodes, cyclic voltammetry and stripping voltammetry were performed using a CHI 900 electrochemical workstation. A three-electrode arrangement with a Ag/AgCl reference electrode (CH Instruments) and a Pt-wire counter electrode was employed. Electrochemical cells are as follows:

Ag|AgCl|KCl (3 M)∥x M TEACl or TPACl in 0.01 M LiSO₄ (aq)|PVC membrane|PEDOT|Au (cell 1)

Ag|AgCl|KCl (3 M)∥y M LiAsF₆ in 0.01 M LiSO₄ (aq)|PVC membrane|POT|Au (cell 2)

A piece of Teflon tube was put on a modified Au electrode tip for cyclic voltammetry to obtain a disk-shaped PVC membrane/water interface with the diameter of 1.5 mm and the interfacial area of 0.0177 cm². The tube was not used for stripping voltammetry, where a PVC/PEDOT- or PVC/POT-modified electrode was rotated by using a modulated speed rotator (Pine Research Instrumentation). A preconcentration potential was set near the limit of the potential window to obtain a steady-state liming current, i₁, by rotating-electrode voltammetry. The potential sweep rate during a stripping step was slow enough to exhaustively transfer preconcentrated ions from the PVC membrane into the aqueous sample.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A sensor, comprising:
a working electrode comprising:
a first layer formed of a polymeric material, the first layer comprising a first surface across which an analyte in a sample can be transported and a second surface generally opposite of the first surface, the first layer satisfying the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10;
a second layer in contact with the second surface of first layer, the second layer adapted to undergo at least one of a reduction reaction or an oxidization reaction; and
a support comprising a solid electrically conductive material in electrical connection with the second layer.

2. The sensor of claim 1 wherein σ is no greater than 7.

3. The sensor of claim 1 wherein σ is no greater than 1.

4. The sensor of claim 1 wherein the second layer comprises a conductive polymeric material.

5. The sensor of claim 4 wherein the conductive polymer is one of a polypyrrole, a polythiophene and a polyaniline.

6. The sensor of claim 4 wherein the conductive polymer is poly(3-octylthiophene) or poly(3,4-ethylenedioxythiophene).

7. The sensor of claim 4 wherein the first layer operates as a liquid membrane.

8. The sensor of claim 4 wherein the first layer operates as an ion-selective liquid membrane.

9. The sensor of claim 4 wherein the first layer comprises a plasticized polymer.

10. The sensor of claim 4 wherein the first layer comprises polyvinyl chloride, a substituted polyvinyl chloride, a cellulose triacetate, a polyurethane, a polymethacrylate or a silicone rubber.

11. The sensor of claim 4 wherein the first layer comprises a plasticized polyvinyl chloride

12. The sensor of claim 4 further comprising circuitry to apply a potential to the electrically conductive material.

13. The sensor of claim 12 wherein the circuitry is operable to apply a potential to the electrically conductive material in a first direction to cause analyte from the sample to concentrate in the first layer.

14. The sensor of claim 13 wherein the circuitry is operable to reverse the potential applied to the electrically conductive metal to a second direction to cause analyte to exit the first layer and reenter the sample.

15. The sensor of claim 14 wherein the circuitry is also operable to measure a current resulting from transfer of analyte across the first surface of the first layer

16. The sensor of claim 15 wherein the first layer comprises plasticized polyvinyl chloride.

17. The sensor of claim 16 wherein the second layer comprises poly(3-octylthiophene) or poly(3,4-ethylenedioxythiophene).

18. The sensor of claim 15 further comprising a mechanism to impart motion to the working electrode.

19. The sensor of claim 18 wherein the mechanism imparts rotational motion to the working electrode.

20. The sensor of claim 15 wherein the circuitry is operable to set the potential applied to the electrically conductive material in the first direction and to vary the potential applied in the second direction to perform linear sweep or other voltammetry.

21. The sensor of claim 4 wherein the conductive polymer is poly(3-octylthiophene) and the first layer is plasticized polyvinyl chloride having an effective thickness no greater than 1 μm.

22. The sensor of claim 4 wherein the conductive polymer is poly(3,4-ethylenedioxythiophene) and the first layer is plasticized polyvinyl chloride having an effective thickness no greater than 3.25 μm.

23. The sensor of claim 1 wherein the first layer further comprises at least one electrolyte.

24. The sensor of claim 1 wherein the first layer further comprises at least one entity to associate with the analyte to facilitate transport of analyte into the first layer from the sample.

25. The sensor of claim 15 further comprising a counter electrode and a reference electrode.

26. The sensor of claim 4 wherein the second layer has a thickness no greater than 1 μm.

27. A working electrode for use in a sensor, comprising:
a first layer formed of a polymeric material, the first layer comprising a first surface across which an analyte in a sample can be transported and a second surface generally opposite of the first surface, the first layer satisfying the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10;
a second layer in contact with the second surface of first layer, the second layer adapted to undergo at least one of a reduction reaction or an oxidization reaction; and
a support comprising a solid electrically conductive material in electrical connection with the second layer.

28. A method of detecting an analyte in a sample, comprising:
a. placing a working electrode in fluid connection with the sample, the working electrode comprising:
a first layer formed of a polymeric material, the first layer comprising a first surface across which an analyte in a sample can be transported and a second surface generally opposite of the first surface, the first layer satisfying the formula l≦(σDₘRT/|zᵢ|Fv)^{1/2}, where l is effective thickness of the first layer, Dₘ is a diffusion coefficient of an analyte in the membrane phase, R is molar gas constant, T is temperature, zᵢ is a charge of an analyte or ion-analyte complex, F is faraday constant, v is a rate of a potential sweep during a stripping process and σ is no greater than 10;
a second layer in contact with the second surface of first layer, the second layer adapted to undergo at least one of a reduction reaction or an oxidization reaction; and
a support comprising a solid electrically conductive material in electrical connection with the second layer;
b. concentrating analyte in the first layer over a period of time;
c. applying a potential to the electrically conductive material to cause analyte in the first layer to transport across the first surface into the sample; and
d. measuring a current resulting from transport of analyte across the first surface.
